(19) United States
(12) Patent Application Publication
(10) Pub. No.: US 2006/0004588 A1
(43) Pub. Date: Jan. 5, 2006

(54) Method and system for obtaining, maintaining and distributing data

(76) Inventor: Mohan Ananda, Westlake Village, CA (US)

Correspondence Address: THE HECKER LAW GROUP, 1925 CENTURY PARK EAST, SUITE 2300, LOS ANGELES, CA, 90067, US

(21) Appl. No.: 10/883,595

(22) Filed: Jun. 30, 2004

(51) Int. Cl. G06F 17/60

(52) U.S. Cl. 705/1

(57) ABSTRACT

A method and apparatus for storing and distributing protected information, while complying with regulations regarding privacy rights, are described. The system receives multiple configuration settings from individuals and from a security officer. Those configuration settings are used to determine access level attributes, which allow others to access the data. Furthermore, the system implements workflow configuration, which allows the system to manage the protected data within a framework of operational procedures. One or more authentication and encryption methods are implemented to assure that data is transmitted and stored with the highest level of security.

### FIELD OF THE INVENTION

The invention relates to computer software, and more specifically to software for obtaining, storing and distributing data in accordance with regulations.

A portion of the disclosure of this patent document contains material which is subject to copyright protection. The copyright owner has no objection to the facsimile reproduction by anyone of the patent document or the patent disclosure, as it appears in the Patent and Trademark Office file or records, but otherwise reserves all copyrights associated with this document.

### BACKGROUND

The wide-spread use of electronic media for storing and distributing information raises the challenge of protecting sensitive data in order to preserve the rights to privacy of individuals and organizations. In some fields, the government has stepped in to define the legal boundaries for possession and distribution of protected information. For example, the Department of Health and Human Services has published the Health Insurance Portability and Accountability Act (HIPAA) with the aim to cover such rules as how medical information is to be accessed.

For medical information, as well as for financial information and other sensitive forms of data, governmental rules and regulations set standards for the security of the electronic protected information. Those standards require that measures be taken to secure information while it is in the custody of specific, enumerated entities, as well as while the information is in transit between those entities or between those entities and a third party. Each enumerated entity engaged in the electronic maintenance or transmission of information pertaining to individuals (or organizations) must assess potential risks and vulnerabilities to such information in its possession in electronic form and develop, implement, and maintain appropriate security measures to protect that information.

HIPAA rules, for example, set standards for how private health information should be controlled and protected by setting forth what uses and disclosures are authorized or required and what rights patients have with respect to their health information. Those security standards require covered entities to implement basic safeguards to protect electronic health information from unauthorized access, alteration, deletion, and transmission.

Currently, no prior art systems for managing and maintaining electronic medical information meet the security standards set by the rules of HIPAA. None of the prior art systems address the security concerns that have been identified by the security standards adopted under the rules.

Lawrence et al, (U.S. Pat. No. 6,272,481) implements a hospital based integrated medical computer system for processing medical and patient information. The Lawrence system includes a medical processor having a memory and multiple medical data banks connected thereto. The latter system is designed for use in a network environment using an integrated services digital network (ISDN). However, the Lawrence system does not address the security concerns of HIPAA and does not meet the security standards developed under the rules.

Another medical information system, Bocionek, et al. (U.S. Pat. No. 6,551,243), processes information from multiple sources suitable for access by health care personnel for use in clinical care delivery. The latter system includes a communication interface for receiving information from patient monitoring devices, and for bidirectionally communicating with a hospital information database containing patient records. This system also includes a data processor using the communication interface for acquiring patient record information from the hospital information database and for acquiring data from the patient monitoring devices. The data processor also updates the patient record information by communicating to the hospital information database. This system does not address any of the security concerns related to the privacy of medical information of a patient and the security standards set to meet the requirements of HIPAA.

Thus, existing systems fail to meet security standards, such as those developed under the HIPAA security rules. There is a need for a system that provides security and end-to-end protection of information stored and distributed in electronic form.

### DESCRIPTION OF THE DRAWINGS

FIG. 1 one is a block diagram of a data security system in accordance with one or more embodiments of the invention.

FIG. 2 is a block diagram of several processes involved in securing communication, validating data, securely storing the data and securely tracking data manipulation, in accordance with one or more embodiments of the invention.

FIG. 3 is a block diagram of the interaction between a system embodying the invention and several clients, illustrating the cascading of security privilege grants, in accordance with one or more embodiments of an invention.

FIG. 4 is a flow chart illustrating a process for acquiring security configuration information in accordance with one or more embodiments of the invention.

FIG. 5 is a flowchart illustrating the process of cascading security privilege attribution based on task workflow, in accordance with one or more embodiments of the invention.

FIG. 6 is a flow chart illustrating a process for receiving and storing data in accordance with one or more embodiments of the invention.

FIG. 7 is a flowchart illustrating a process for accessing protected data, in accordance with one or more embodiments of the invention.

FIG. 8 is a flowchart illustrating a process for fulfilling notice requirements in accordance with one or more embodiments of the invention.

FIG. 9 is a flow chart illustrating a process for printing protected information using security attributes, in accordance with one or more embodiments of the invention.

FIG. 10 is a flowchart illustrating an event-triggered process for updating security levels, in accordance with one or more embodiments of the invention.

### SUMMARY OF THE INVENTION

The invention provides a method and apparatus for obtaining, maintaining and distributing protected data. A system embodying the invention may provide multi-level protection with data encryption and authentication technologies for providing time-based selective access to authorized users and/or third party systems.

Embodiments of the invention may be used to fulfill government-promulgated standards for systems that receive and store individuals' data. For example, medical data can be gathered, stored and/or distributed electronically, in compliance with HIPAA guidelines on how to preserve the individuals' right to privacy while managing medical data. The system may also integrate individuals' configuration (e.g. privacy and security rules), which the user in question provides to the system. Furthermore, the system allows a security officer to input rules that may determine how the governmental rules and regulations and/or the user's rules are applied to the data management procedures.

A system embodying the invention may obtain rules data in one or more forms. The system is capable of supporting local and remote electronic communication with users and other systems (e.g. a health monitoring system). Individuals may connect to the system through a local client machine or remotely through a network (e.g. the Internet) using one or more user interfaces. A person may securely connect to the system (e.g. using a client application that utilizes data encryption), and enter configuration information, which the system stores in encrypted form and uses for defining the manner in which the data is stored and distributed to other users or other systems.

One or more embodiments of the invention are capable of meeting the security requirements in all phases of electronically collecting, maintaining, using and transmitting medical information (or other sensitive information in need of such security controls). The system protects the data and prevents inappropriate access, modification, dissemination and destruction of the data.

The present invention may be embodied in various models. For example, one embodiment of the invention is directed to a system that comprises a plurality of processing modules executing either on a single machine or on multiple machines, the clustering and/or compartmentalization of which may be designed to provide extra-security at each step of the data management procedures. For example, the system may comprise a communication layer that handles communications with a user (or with another system) using one or more encryption and authentication methods. In one embodiment, the encryption and authentication methods of this communication layer may be different from the methods used within separate modules in the system. For example, the encryption methods utilized in communicating with the user may be different from those utilized in encrypting data for storage in a database.

The system may also comprise a plurality of sub-systems that handle data processing and communication, while sharing a centralized database system for storing data. In the latter case, the database system may serve as a back-end for all other processes and sub-systems. The communications sub-systems may be co-located in proximity with the database, or they may be enabled to securely access the database remotely. Embodiments of the invention may implement encryption techniques to make any data connection safe for the transmission of data, and to prevent unauthorized access to the data.

In an embodiment providing HIPAA-compliant data protection, the system is capable of being integrated with any existing medical information system, given the proper interfaces. The input to and output from the system may be handled by transaction modules. The transaction modules are a set of software modules residing on one or more servers, which allows browser access to the system through any computer terminal (e.g., utilizing either a private area network or through a public network over the Internet).

When the system is deployed, it may be accessed through the Internet. Furthermore, security measures may be taken to protect against threats and attacks through the Internet. The system may implement any available software and hardware tools (e.g. firewall technology, smart switching hubs or any other data protection technology) to protect data from various types of attacks. The system may also be configure to incorporate any future data protection and security technologies.

A system embodying the invention may acquire security rules in accordance with regulations that cover the data. The system may acquire authorization settings from the user, specifying whether to allow or deny access to others. The system may also acquire rules that a security officer inputs into the system. The security officer's rules may determine how the above rules are applied and further establish procedures for some automatic processes that control the workflow.

For example, with regard to health-related data that falls within the HIPAA regulations, a system embodying the invention may be based on the general principle that the medical information of a patient can only be disclosed to others with specific authorization from the patient. Any other disclosure of such information is only permitted through a court order or by specific government regulations. However, as per HIPAA privacy rules, a health care provider that has a direct treatment relationship with an individual is not required to obtain the individual' s consent prior to using or disclosing information about him or her for treatment, payment and/or health care operations. The system, however, may make provision for obtaining consent from the patient, and may make exceptions under special conditions, such as a medical emergency.

One or more embodiments of the invention implement procedures for capturing user settings, regulations data and the input of a security officer. For each individual, the system may provide a registration phase in which the user's initial information (e.g., personal information and/or security preferences) is entered into the system. The system then receives the data to be protected. At any stage of the receiving and handling of the data, the system may authenticate a user (or system) requesting access to the data, and utilize the stored credentials of the user accessing the data to determine the access level that may be assigned to each specific user and each specific type of information. For example, in a health care facility, a doctor assigned to a patient may be allowed access to all medical information about the patient, while an agent in the accounting department may be limited to accessing the type of procedures the patient undergoes, for the purpose of invoicing the patient with medical fees.

Embodiments of the invention may implement methods by which access privileges are automatically set up for successive steps in procedures that involve multiple parties at successive stages of the procedure. For example, a patient admitted to a healthcare facility may undergo a number of tests and an operation, all of which involve several distinct departments. For example, the patient may be referred to a laboratory to conduct physiological tests, then to a radiology department to undergo a medical imaging investigation.

The system embodiment may automatically check the credentials of the persons involved in providing the medical assistance, and may configure the access level attributed to each person or system on an as-needed basis following the HIPAA rules. Furthermore, the system may determine a time factor, that is, a period during which the authorized person(s) may access the data, and after which the authorization expires.

Using events, a system embodying the invention may also configure successive stages of access privileges. For example, a radiology department entering the results of a radiological test may constitute a trigger event to disallow any further access privileges to the radiology agents and further allow access to the persons involved in the next stage of the medical procedures.

### DETAILED DESCRIPTION

The invention provides a method and apparatus for obtaining, maintaining and distributing data protected under regulations. Embodiments of the invention provide protection of data through a multi-tiered system that implements encryption technologies for encrypting data, and authentication technologies for providing selective access to authorized users.

In the following description, numerous specific details are set forth to provide a more thorough description of the invention. It will be apparent, however, to one skilled in the art, that the invention may be practiced without these specific details. In other instances, well known features have not been described in detail so as not to obscure the invention. The claims following this description are what define the metes and bounds of the invention.

Terminology

In the following description, the term “user” may refer to a person using a computer application and/or to one or more processes interacting with a computer application or system. A process may be any computer program executing locally or remotely and which may be triggered by one or more events. An event is defined as the occurrence of a low-level action (e.g., establishing a network connection or opening a file), a high-level action (e.g., receiving registration data from a user), or a combination of actions (e.g. receiving approval from an officer upon receiving user registration data).

The invention described herein is set forth in terms of methods and systems implementing those methods. It will be apparent, however, to one with ordinary skill in the art that the invention may be implemented as computer software, e.g., computer program code capable of being stored in the memory of a digital computer and executed on a microprocessor.

A “server” may be, for example, a single machine that acts as a server, or a computer program executing on that hardware to provide a service (e.g., a web server). Furthermore, a server may comprise one machine or a cluster of machines configured to provide a service. Some machines may execute multiple virtual machines or server processes providing one or more services.

References to “connections”, such as client and server connections or network connections, do not necessarily involve a physical network such as an Ethernet network. Clients and servers may reside on the same machine. For example, web servers (e.g., Apache Web Server) and one or more application servers may be running on the same physical machine. The network connecting an application server and a web server is, in this case, a virtual network. Embodiments of the invention are capable of running on virtual networks as well.

References to a “data source” refer to any type of means that allow a computer to obtain data using one or more protocols. For example, a data source may be a flat file residing on a file system, an electronic mail server, a Lightweight Access Directory Protocol (LDAP)-based server or any other type of means capable of serving data. References to a database may alternatively refer to a data source. In the case of a relational database, a schema is conventionally used (e.g. star schema) to refer to the structure/organization of data in the relational database. Therefore, in the disclosure a reference to a database schema may read as a data structure/organization that characterizes the data source in question (e.g., electronic mail server or LDAP server).

The invention may be implemented as a computer program based on a modularized architecture as will be described below. Each component may be implemented as part of a larger infrastructure (e.g., within an application server) or as a plug-in, applet, DLL (dynamic link library), etc. that may be embedded within, or interfaced with third party applications. Though described in modular terms for purposes of illustration, embodiments of the invention need not be confined to a modular structure. Functionality described herein may be implemented in software (and/or hardware) as a single process or as a combination of multiple processes.

The following description specifically references certain encryption methods. However, any available encryption method may be adapted for use at any level within an embodiment of the invention. Some examples of known encryption methods include Data Encryption Standard (DES) and Rivest Shamir Adleman (RSA). Similarly, Embodiments of the invention may be implemented with known validation and error correction schemes. Some examples of available technologies for validation and error detection include secure shell applications and checksums for blocks of data.

References to the “protected individual” refer to the individual that is the subject of the protected data, e.g., the patient whose medical information is protected or the business client whose financial data is protected.

Overview

Generally privacy rules require individual authorization for use and disclosure of protected information for purposes that are not otherwise permitted or required under the rule. Some examples of possible authorization requirements are as follows: (1) a description of the information to be used or disclosed; (2) the identification of the persons or class of persons authorized to use or disclose the protected information; (3) the identification of the persons or class of persons to whom the covered entity is authorized to disclose the protected information, or on whose behalf the protected information is to be used; (4) a description of each use or disclosure; (5) an expiration date or event; (6) the authorizing individual's signature and date; and (7) if signed by a personal representative, a description of his or her authority to act for the individual.

An embodiment of the invention (the “system”) is designed to obtain an authorization from the individual, such as an electronic signature and eventually a hard copy signature (e.g., by printing an authorization page from the system). The system may be configured to incorporate different types of authorization forms (as may be mandated by privacy rules), such as for research or marketing purposes, so that both electronic and hard copy signatures may be obtained from the individual. The system may also be configured to handle any requirements for de-classifying protected data or identifying limited-access data so that such data (e.g., non-identifying health information) could be generated and disclosed without specific authorization of the protected individual.

In one or more embodiments of the invention, the regulation data and/or the user or the security officer may determine that one or more elements or sets of data may be shared with a third party, while preserving the anonymity of the person associated with the data. For example, since health care information is a very useful tool for research and development in the field of medicine, health institutions are enticed to share medical treatment results. A system embodying the invention is capable of extracting information in a de-identifying manner (i.e., disassociating the data from the data owner), preserving the anonymity of the person involved.

The system may determine the elements of data which may be disclosed, and de-identify that data. For example, in one embodiment de-identifying the data may be achieved by creating a set of data (e.g., a set of database tables) that does not include any of the personal information, and which the system may link to such personal information through an identifier (e.g., a randomly generated identification number that is uniquely associated with a person's information). When data is provided to a third party (e.g., for a study, an audit, etc.), only that data in the separate data set is accessed. Personal information of the data owner is kept inaccessible to such data gathering operations (e.g., the link/association to the personal information is not known and/or not traversable by the data gathering process). The de-identified/declassified data gathering process may also be restricted to collecting all or part of such data in aggregate (e.g., data for multiple subjects may be lumped together), such that particular data value combinations that otherwise might be used to identify a particular data owner through correlation are obtained as uncorrelated sum values.

In one embodiment, the system is designed to create notices to be provided to the protected individual by the covered entity, e.g., to meet privacy rules. The system may be configured to send those notices automatically (e.g., as voice mail or electronic mail) to the protected individual. Furthermore, access to the message by the protected individual may automatically generate an acknowledgment of the receipt of the notice (e.g. by sending an electronic mail back to the system). The system may be designed to properly authenticate such a return email and make it part of the protected individual's record. The system may provide an accounting of disclosures of protected information (e.g., including copies of the disclosure notices from the individual's record) when requested by the protected individual.

In one or more embodiments, the security of the system may be managed and maintained by an information security officer (ISO) of the entity deploying the system. The deploying entity is responsible for setting up policies and procedures that specify when persons should have access to information. Those policies and procedures set by the entity for the routine and non-routine receipt, manipulation, storage, dissemination, transmission, and disposal of individuals' protected information may be periodically updated.

The information security officer becomes the custodian of the information on behalf of the entity. The security officer may delegate authority to access the information to others within the entity through context-, role-, or user-based access, or as prescribed by the policies and procedures developed by the entity. Such access may be temporary in nature and based on the specific need.

The system may be enabled to grant users access to information based on several usage categories, such as: (1) access to input information into the system either directly, through a remote terminal or from another system or entity; (2) access to retrieve information from the system for display only, e.g., at a terminal with or without the print attribute (see below for further detail); and (3) access to information for distribution to another system or entity.

System Deployment Environment

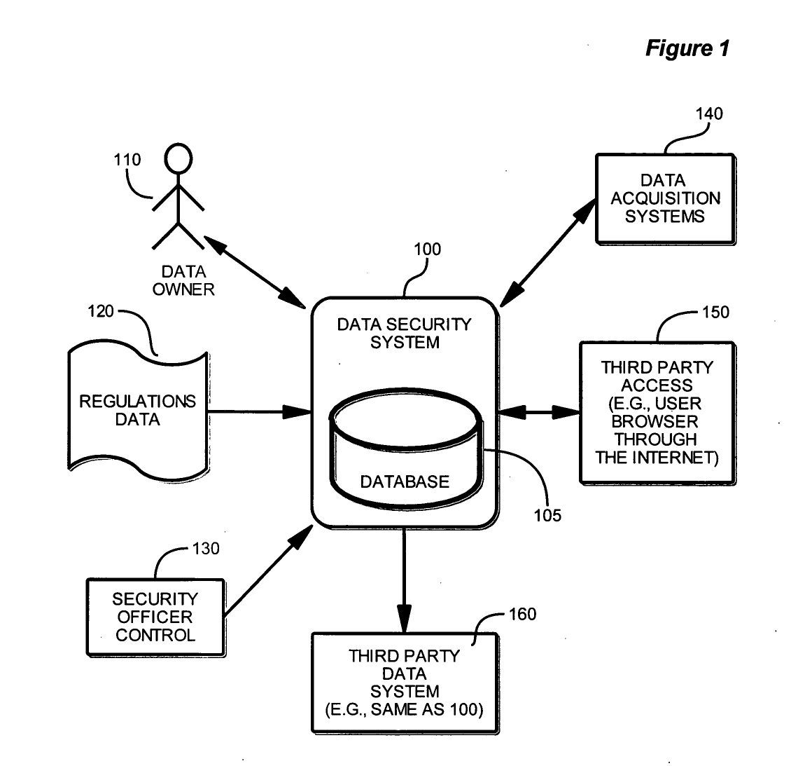

FIG. 1 one is a block diagram of a data security system in a deployment environment, in accordance with an embodiment of the invention. Block 100 represents a data security system embodying the invention. Data security system 100 may include multiple software modules for data processing and a database system 105 for storing information. The system 100 is enabled to interact either locally or remotely with users such as the data owner 110 (i.e., the protected individual). The system may provide one or more user interfaces to interact with users or other systems. For example, a system embodying the invention may be deployed in a healthcare facility enabling patients (patient data owner 110) to access the system (locally or remotely), register, input personal information, and input security information such as selecting an access password.

Block 120 represents a set of regulation data. The regulation data may be any set of rules directed at protecting individuals' privacy with respect to storing and distributing information. For example, HIPAA establishes the rules for protecting and distributing a patient's information as he or she is given health care. As another example, regulations that protect financial information during monetary transactions may also be presented as regulation data. System 100 may be configured to receive regulation data and translate that regulation data into a format for integration with the existing security rules.

Block 130 represents security officer controls. The security officer is typically a person who has the responsibility of managing the security on the system to allow and/or deny access to protected information by any user or third party system. In one or more embodiments, the system implements one or more software modules that allow the security officer to configure the system in multiple ways.

System 100 may implement interfaces to enable the security officer to set up the system and rules to support interaction with other parties, such as data owners or third parties that may access the system to retrieve information. The security officer may configure a hierarchy of access privileges for a party. The security may also configure how the regulation data is implemented into the system.

System 100 may implement workflow procedures that are closely tied to data security configuration. For example, system 100 may automatically update the security attributes associated with a particular portion of information based on a procedure and the context of the procedure execution.

Block 140 represents data acquisition systems. Data acquisition systems 140 may include, for example, any systems capable of transmitting data to system 100. For example, in a healthcare facility the system may receive data from health monitoring services. The data may be automatically captured or entered manually. In a business environment, data acquisition system 140 may include one or more computers that capture information regarding financial transactions involving a particular user. The computers may communicate with system 100 (e.g., over a network) to transfer the financial transaction information.

Block 150 represents third party access. Examples of third party access may include users of a network that are allowed access either locally or remotely. System 100 may provide access based on rules set by one or more of the following: the data owner 110, the regulations 120, or the security officer 130. For example, regulations may impose a rule to make some data owned by data owner 110 publicly accessible to anyone. In this case, system 100 may allow access to third parties using a web browser application to view the data from the Internet.

Block 160 represents a third party data system. Third party data system 160 may be designed to provide data security in a manner similar to system 100. System 160 may be any system that is designed to provide data security and that is used by a separate entity (e.g. a business entity, financial institution, healthcare facility or any other institution using a data security system). System 100 may interact with third party systems, for example, to exchange encryption information. System 100 and system 160 may exchange credentials to check whether the two systems are configured to interact with each other, whether parts or all of the information may be exchanged between the systems, or whether the systems may request more configuration data to allow such an exchange.

Data may be entered into the system manually through a remote terminal, or directly from a device or an external system within or outside the deploying entity. In one embodiment, direct data entry may be prohibited without a specific authorization from the security officer. An external system or a device may be treated as a remote terminal, and proper authentication of the external system or device may also be required prior to inputting the data into the secured system 100. The data entered into system 100 may be decrypted and re-encrypted using the internal system key prior to storage of the data in the database server.

A system embodying the invention may be deployed within any entity (e.g., organization) to provide a data security system that functions under prescribed data manipulation rules.

In a typical setting, an embodiment of the invention provides continuous operation. To this end, the system embodying the invention may be implemented in a secure environment that utilizes any available hardware and software technologies for insuring availability. Such technologies, for example, involve firewalls that process network packets and prevent a number of attacks (e.g., packet spoofing), computer virus detection technologies and any other available data protection technology. The system may also be implemented on hardware that provides fail-over technologies that substitute (or switch off) hardware components when they may show early signs of failure.

In addition to implementing available fail-over and firewall technologies to protect the data and the secure communications, the system may also be configured with capabilities for monitoring proper functioning of the system. In one embodiment, the system may continuously monitor the data and attempt to detect any violations of the working rules.

As an example, the system may determine that certain access privileges were improperly assigned to a given set of data in violation of the working rules. In this case, the system may determine that such an event is a vulnerability and proceed to take counter-measures to prevent any exploitation of the vulnerability by malicious users, and/or further degradation of the functioning of the system. Among the counter-measures a system may take may include, but are not limited to: notifying the system administrator (e.g., data security officer); shutting down elements of the system that provide access to the vulnerability and placing the vulnerable portion of the data in quarantine until review by the security officer; shutting down a portion of the hardware system running the software; implementing new encryption keys, or any other measure that helps minimize any potential damage that may result from such a vulnerability. Operations may be maintained by switching to a redundant system (e.g., redundant data store, access process and/or server hardware). The redundant portion may be used only temporarily, e.g., until the security officer verifies that the vulnerability is removed. Also, access may be more restricted (e.g., a “safe” mode) until the system is cleared of any such vulnerabilities.

Protecting Data By Implementing Rules and Encryption Technology

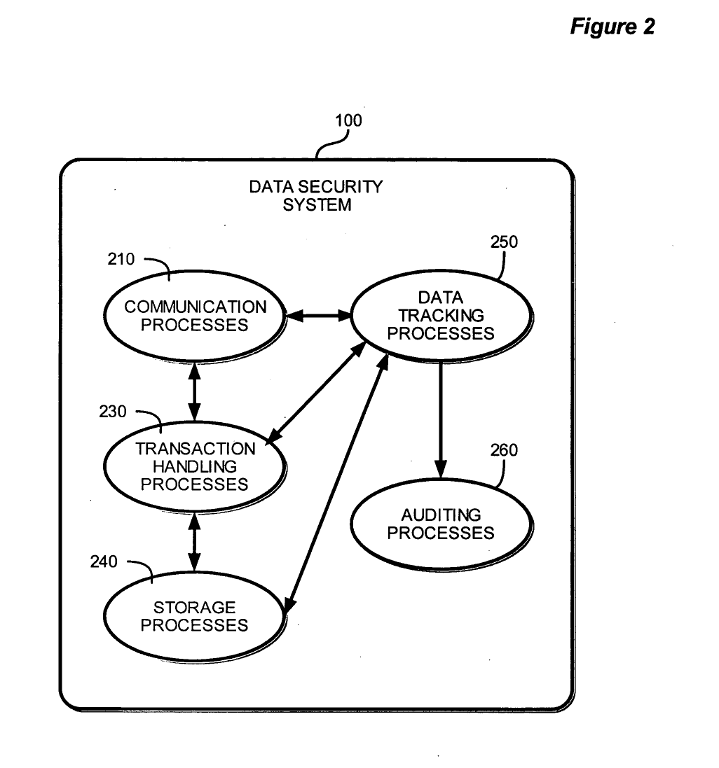

FIG. 2 is a block diagram that illustrates some of the processes involved in securing communication, validating data, securely storing the data and securely tracking all data manipulation in accordance with an embodiment of the invention. Block 100 represents a data security system embodying the invention. Block 210 represents communication processes comprising the software modules that enable the system to securely communicate with other systems and/or user interfaces. Communication processes 210 comprise, for example, the software utilized for encrypting data and opening secure network communication connections with other systems (e.g., using private/public key encryption). Processes 210 may also be configured to identify third party systems; authenticate those systems based on the security information provided locally by the data owner, the security officer, and/or the regulations rules; and verify signatures from those third party systems.

Typically, when the system receives a request for a connection, one or more of communication processes 210 handle the connection request. The communication processes determine the origin of the request and securely authenticate the origin. For example, communication processes 210 may determine whether the connection is requested by a user and established from a client's machine, or the connection is being established from a remote data system, such as 140, for communication with system 100 and transfer of data. In the latter situation, once the communication processes authenticate the validity of the source machine and the access priority allowed to the source machine and/or the user, system 100 establishes encryption keys (e.g., by exchanging public keys for public/private key encryption).

Block 230 represents the processes that are involved in handling data transactions. For example, when the communication layer of system 100, (i.e., block 210) determines that an incoming connection from a third party system or from a user's machine has access or is granted access to the system, communication process 210 receives the data (e.g., input data from a user or a third party system) and communicates the data to transaction handling processes 230.

Transaction handling processes 230 may conduct a number of actions on the incoming and outgoing data. For example, transaction processes 230 may check the validity of the data, e.g., by comparing the information in the incoming data to existing information in the system. A typical example of such a comparison would be comparing a patient's identification number within data from a health care monitoring system, with a locally stored identification number. Transaction handling processes 230 may further process the incoming data to establish access privileges based on stored information in system 100, such as setting access privileges based on security information provided by the data owner, the security officer, regulations, or by a combination of the foregoing.

Block 240 represents storage processes. Once incoming data is validated, authenticated from its source and processed to make it compatible with the set rules in the system, system 100 processes the data for storage. Processing data for storage may involve using an encryption scheme to encrypt the data before it is sent to a storage system, such as a relational database system. By encrypting the data before storage, system 100 ensures that stored data is not easily accessible, because the data may not be decrypted without the encryption key even if the encrypted data is somehow improperly accessed.

In one or more embodiments of the invention, storage processes 240 may use an individual encryption key for the storage of each individual's data. This enhances protection because illegally retrieved information may not be decrypted without possession of the specific key (e.g., password) for the individual whose data is being accessed.

Block 250 represents data tracking processes. Data tracking processes 250 comprise the software and hardware modules that track all the events occurring within system 100. Tracking processes 250 may log all of the information related to network communication attempts made into and out of system 100. Tracking processes 250 may also track authentication events conducted by communication processes 210, transaction handling events of processes 230, and read and/or write storage accesses via processes 240.

Block 260 represents information auditing processes. Auditing processes 260 comprise software and/or hardware means that provide reporting capabilities that allow the system to capture any access or attempted access to the system with all pertinent information details. Such details may include, but are not limited to: the identity of the accessor, the date and time of the access event, session identification and contact time, any input/output information, information requests, and any other activity during the contact with the system. The system may encrypt the audit trail data, and may store such data in the database or in a separate data repository.

Audit trail data may also be configured with separate access privilege properties allowing the security officer access to the data, and the capability to configure access privileges for a third party. For example, a third-party auditing institution may be required to access the auditing trail data in order to investigate the proper functioning of the system and certify the compliance of the system with the regulations.

Furthermore, audit trail data modules 260 may detect suspicious or attempted unauthorized intrusion into the system, and be enabled to immediately notify an administrator (e.g., the security officer) in order to preserve the integrity of the system.

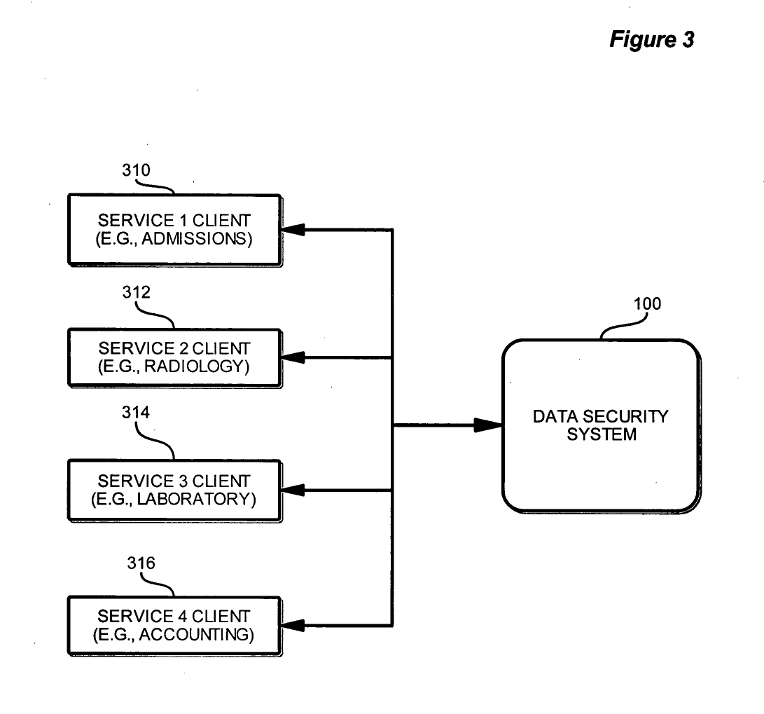

FIG. 3 is a block diagram that illustrates the interaction of system 100 and several clients. Generally, system 100 is centrally located to communicate with a number of clients (310, 312, 314 and 316) under prescribed privacy rules. To exemplify an environment in which an embodiment of the invention may be deployed, system 100 is considered below within the context of a healthcare facility where patients' information and health information are all subject to HIPPA regulations. (Note that the invention may be embodied in other contexts to provide data security and protection. For example the system may be deployed within a financial institution where management of user information is subject to rules and regulations.)

In FIG. 3, system 100 represents an embodiment of the invention acting as the central facility that handles the operations of: receiving input from the patient with regard to access handling of security information; and managing access by facility personnel, such as medical doctors or other personnel involved in the operation of the healthcare facility.

Block 310 represents a client machine that is used to allow access to a user to register with system 100 and input security information based on individual preferences. For example, such a client maybe a computer in the admissions department at a hospital. When the patient is admitted, the admission department inputs a variety of information such as physical data (e.g., weight, height, age etc.). The healthcare provider and/or the patient may input other information such as insurance information, and other information related to healthcare, such as patient health history (e.g. history with any disease or hereditary disease or allergies or drug use etc.).

The system may allow the patient to select access keys, such as user name and password, and may also provide an input mechanism (e.g., a GUI button) for the patient to signify agreement with and/or acknowledgement of regulations and local agreements, such as hospital agreements. The patient may input security access information, though some of the security access information may already be pre-entered by the security officer. For example, some information may be made accessible throughout the departments that will be involved in healthcare procedures. Such information may include the patient's name and time of admission, for example, which can be accessed by all departments that may need to know whether that patient is currently on the premises.

Upon admission of the patient, system 100 may use the information obtained from the patient to configure many access privileges for subsequent procedures. For example, the admissions department may assign a specific medical doctor to the patient. In this case, system 100 may allow that specific medical doctor, or a team of doctors that are involved in a subsequent medical procedure, to access that patient's data.

In one or more embodiments, system 100 may assign a hierarchy of access privileges. For example, when a patient has been assigned to a medical doctor and that doctor prescribes a number of healthcare procedures (e.g., taking x-rays or having a blood test), system 100 may automatically grant privileges to persons that are identified as members of the departments in which the prescribed procedures will be performed. The automatic privileges are granted based on the configuration rules, regulations and setup provided by the security officer.

Access privileges may be specific to certain individuals and may have time-related attributes. For example, the access privileges assigned to a group, such as the radiology department, may be granted for a duration of 24 hours following admission of the patient or the doctor's request for an x-ray procedure. Time constraints allow the personnel involved in the procedures to have access to the patient's information during the timeframe within which the patient's information is likely to be needed and/or new information is likely to be gathered and input into the system, e.g., during the span when the given procedure is likely to be performed or results will be available. However, if the expected flow of information is interrupted, e.g., if the patient leaves the facility without completing all of the prescribed procedures, system 100 may automatically terminate any further scheduled access privileges.

In FIG. 3, block 312 represents a second client application or machine that communicates with system 100 to access and enter data. For example, a computer in the radiology department may be used by the personnel that need access to patient information for taking and processing x-rays. Once the procedure has been completed and the data resulting from that particular procedure (e.g. taking x-rays) has been input into system 100, system 100 may consider that step in the procedure as completed and automatically turn off some or all of the data access privileges to the personnel that completed the procedure.

Block 314 represents a client that is part of yet another department connected to system 100. For example, when a patient is admitted to a hospital, the laboratory personnel that are typically involved in performing tests on the patient may be automatically granted access to the patient's information based on their setup rules. The access privileges may be granted by the system based on the initial information entered at the admission phase or as a cascading event that is triggered after the patient has completed a given phase. For example, if the doctor orders that blood tests should only be made following a specified x-ray result, then system 100 may trigger a grant of access privileges to the laboratory personnel after the x-ray result data is entered into system 100 by the department of radiology. As in the previous case, the access privileges may be granted on a durational basis such that, if the laboratory task is not completed within a given period of time, system 100 considers the laboratory access phase expired.

Block 316 represents a client that belongs to a category of users that may be granted access to only a certain subset of patient information (e.g., information relevant to accounting). As in the previous cases, system 100 may grant access to the users based on the nature of the operation in which the user is involved. For example, an accounting department may not have access to details of the physiological data of the patients, but rather may have access to the identification numbers of procedures performed (e.g. blood tests or x-rays) to prepare a bill for those procedures. The accounting department personnel do not need, and therefore are not granted, access to details about the patient's condition, the results of those procedures or any other information that is not pertinent to preparing an invoice.

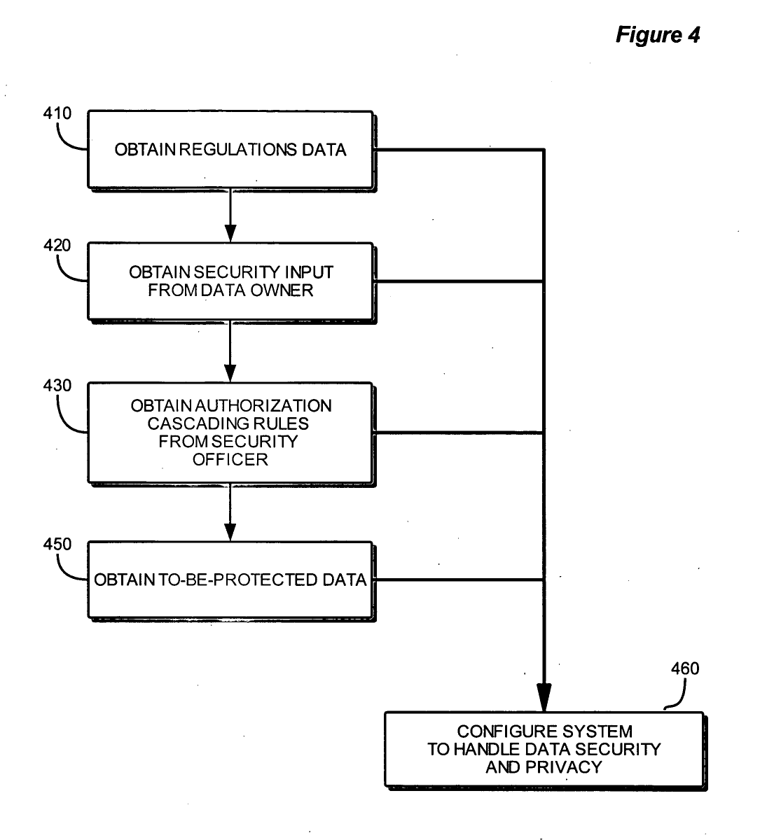

FIG. 4 is a flow chart depicting a process for acquiring security configuration information, in accordance with an embodiment of the invention. At step 410, system 100 obtains regulation data. For example, system 100 may provide a user interface for a person to input regulation data. The system may also implement an automatic process to retrieve or update regulation data. The system may obtain the regulation data and translate it into a form that is compatible with the system configuration to implement security and protection of the data.

At step 420, system 100 obtains security input from a user. In some cases, the user may be the legal owner of the data. For example, a patient admitted to a hospital is the legal owner of data related to the patient's health. System 100 allows the user to input security information, such as the designation of certain users or institutions to which the user wishes to grant access privileges. The user also uses the system to obtain or select individual access information, such as a login name and a password for a subsequent data access, as well as keys for specifically encrypting the data. In one example, system 100 may use the login identification and the password to generate a key which is used for encryption of portions or the whole of the data that is stored in the database. The system provides a user interface for the user to access the system locally or remotely. For example, the user may use any client machine in an Internet connection to access the system using a web browser application enabled to communicate with the system using a private/public key scheme for encrypted data.

At step 430, the system obtains input from the security officer. System 100 provides an interface to the security officer either locally or remotely using similar schemes as described above. The security officer typically devises rules for securing the data, which involves configuring the system to obtain the data and store the data following regulation rules. Other input data are concerned with rules that establish the procedures for granting access privileges to individuals or specific departments. The rules are also concerned with establishing expiration times for the access privileges. As described above, cascading rules or access privileges, from one procedure to the next, are input into the system and used to established access privileges based on time and operations events.

At step 450, system 100 obtains the data that is to be protected in accordance with the settings acquired in the previous steps. As described above, the data maybe obtained by directly inputting information (e.g. personal information of the patient), by automatically acquiring data from a third party system (e.g. health monitoring system), or any other system capable of transmitting data to system 100.

At step 460, system 100 utilizes all of the input information obtained from the user, the security officer and the regulation data to configure system 100 to encrypt the data and follow the rules established by the previous steps to assign access privileges to different parts of the data.

Certain secure identity information only known to the security officer may be embedded in the system before generating an executable element of the software, so that the security officer will be the only person who will have initial access to the system. All other access has to be authorized by the security officer. The security officer may also go through the registration process initially. Once the registration is successfully completed, the system is deployed in operation mode.

In the registration phase of the security officer, system 100 may obtain various personal information such as name, employee identification information, social security number and any other security unique information that was only known to the security officer that was used in creating the executable element. Such data may be transmitted to the transaction modules 230 using encrypted communication. Transaction modules 230 verify whether the security officer's data is complete. If the data is complete, modules 230 retrieve the stored encrypted security officer's personal data from the database server, decrypt the encrypted data and validate the input security officer data by comparing the input data set with the prior stored data set. Once proper authentication and validation are completed, the security officer selects a password, which enables the security officer to access the system in a subsequent operation phase.

In the registration phase for a user, a password may be sent to the system using triple DES. Once the Secure Socket Layer (SSL) triple DES session is established, software at the user's terminal (e.g., a client application, a DLL (dynamic link library), an executed script, a “cookie,” etc.) issues a 64 bit random number (also referred to as a “challenge”) to the server software (i.e., an embodiment of system 100). Using a cryptographic device, the server software digitally signs the challenge using the private key of the server software. The user's software uses the corresponding public key of the server software to verify the digital signature of the server message. If the signature is valid, then the authentication process has been successful and the remainder of the registration process continues.

During the operation phase, once a registered user establishes a SSL session with the communication server (210) of system 100, an additional challenge-response protocol may be used. For example, in one embodiment, the user software and the server software may each be configured with program code (or hardware) to implement the same keyed hashing function. In such an embodiment, the additional challenge-response protocol may be implemented as follows.

The transaction server (230) in system 100 retrieves the user's password from the database server (240) in which it has been stored in an encrypted form and decrypts the user's password. A hashing keyed message authentication code (HMAC) value of the challenge may then be generated using the user's password as the key. The challenge with its HMAC is then sent to the user terminal.

The software at the user terminal uses the user password (e.g., locally stored or input by the user) and the received challenge to verify the received HMAC (e.g., by similarly generating an HMAC value from the password and the challenge, and then comparing with the received HMAC value). If the received HMAC is valid for the received challenge, then the authentication process has been successful. Otherwise the communication between the user terminal and the server may be interrupted and an error message displayed.

For further security, the password may not be saved on the user terminal. All temporary registers and other memory locations that contain user passwords may be erased when a user exits the system. In one or more embodiments, if the user loses the password, it cannot be recovered and the user must go through the registration process again.

With proper authentication, the security officer may authorize various employees of the entity for various levels of access to the system and for different time periods. This may be accomplished, for example, by the security officer entering appropriate identification information related to the respective employees and the relevant access related information into system 100. The security officer may also have the capability to revoke any previous authorizations as needed, such as when an employee is terminated or the need to have the access for an employee is over.

Various authorizations may be obtained from the patient when the patient is admitted through an emergency room or otherwise. The admitting employee, who has either prior authorization (or implied authorization under. the rules) to have access to the system, is able to collect and input the various patient-related data through a remote user terminal, and start creating a patient record in the system. At the time, if the patient is in condition to do so, the patient may create a unique password, give consent and provide various required authorizations for use and disclosure of the protected health information as needed. If the patient is not capable of creating a password and giving consent at the time of admittance, those actions can be done subsequently, when the patient is capable. If the patient is a minor, the parents or the legal guardian may give consent and authorizations in place of the patient, as permitted by privacy regulations.

When the data needs to be transmitted to an outside entity or an external system, a specific authorization from the security officer may also be required. As in the case of direct transmission into the system, proper authentication of the outside entity or the external system is required in one or more embodiments. Such transmitted data may be encrypted using cryptographic key protocols between the systems.

The security officer typically possesses access privileges to administrative information such as user activities, system access status, and any other system operations-related information. The security officer may also obtain periodic summary information with regard to the security system's compliance with various privacy rules and security standards. Moreover, system 100 may notify the security officer when there is an attempt to compromise the system security. The security officer may then perform proper analysis and investigation, and take necessary measures to prevent future occurrences of such situations.

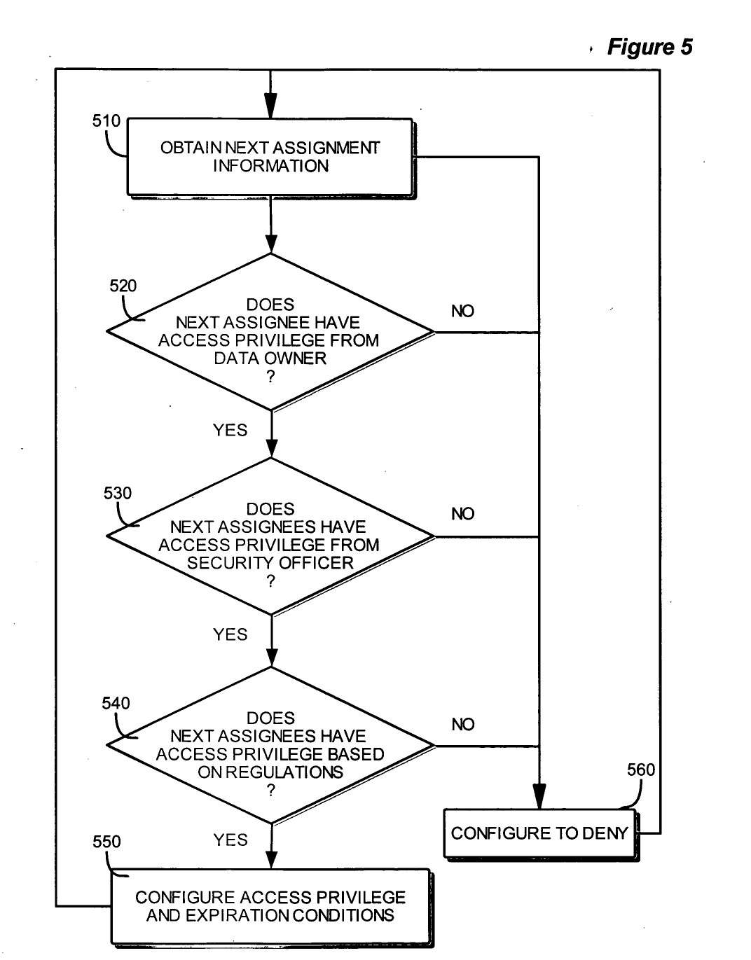

FIG. 5 is a flowchart that illustrates a process for cascading security privilege attribution based on task workflow, in accordance with an embodiment of the invention. At step 510, system 100 obtains assignments (or a task) to be conducted in a succeeding phase of a procedure. For example, as previously described, when a patient is admitted to a healthcare facility, the admissions department inputs information about the patient and information about phases subsequent to the admission phase. For example, the admission department may assign a particular doctor or a team of doctors that are to supervise the process of administering health care. The system may automatically assign data access privileges to individuals who are to be involved in the next phases while following the security officer's input (if any) and any relevant regulations. In the same manner, a doctor who has been assigned to supervise treatments may prescribe any number of tasks where each task involves a designated person or department to carry out one or more operations. As mentioned above, the system has access to personnel and department information which may have been entered at registration. At any phase, the system may access the stored personal information and check the credentials, the availability, authorizations and any other information that may be pertinent to assigning any given task to a person.

At step 520, system 100 checks whether the task assignee (whether the assignee is a person, a team of persons or a department being identified with a specific access code, e.g.) has access privileges from the data owner (e.g., the patient). If the system determines that the designated assignee has access privileges from the data owner, then the system checks at step 530 whether the assignee has access privilege from the security officer. If the system determines that access is allowed by the security officer, the system checks at step 540 whether the assignee has access privileges based on privacy regulations. If the assignee is permitted access privileges by steps 520, 530 and 540, then the system configures the appropriate access privileges at step 550.

After step 550, the process returns to step 510 with the next task/assignee to be processed. If any one of steps 520,530 or 540 denies access privileges, then, in step 560, privileges are denied for the current assignee, and the process returns to step 510 with the next task/assignee. If task assignments are input into the system in a group, then system 100 may configure access privileges (e.g., per the process of FIG. 5) for task assignees ahead of time, in accordance with an expected task timeline or task order. The system may also configure access parameters associated with each task (e.g., return to step 510) as the preceding task is completed (i.e., on an “as needed” basis).

Configuring the access privileges in step 550 may involve, for example, determining an access level for the assignee with respect to the protected data and determining expiration conditions, if any are to be implemented. Expiration conditions may include, for instance, any event (e.g., time-based, procedure-based, etc.) whose occurrence triggers the modification of access privileges. For example, as mentioned above, when a laboratory enters the results of an x-ray and indicates that the radiology phase is complete, the access privileges may be automatically extinguished (or restricted or otherwise modified) for that specific department. Access privileges for another department may also be configured to assert automatically as a new procedure/phase begins with another department, for example.

The system may also determine a time-out period after which, if no action has been taken, the access privileges are modified. This situation may occur, for example, when a patient starts a procedure and then, after entering the initial phases of operations, leaves the hospital without completing any of the other operations.

After completing the configuration for setting up access privileges at a given phase, data security system 100-may set conditions for stopping the assignment process based on specific given events. For example, as mentioned above, the system may use the completion of one phase (or task) to proceed to the next phase (or task). In FIG. 5 proceeding to the next phase will start again at step 510 to retrieve the assignment information for the next phase. Obtaining the assignment information may require the system to prompt the process supervisor (e.g. a doctor supervising the medical operations), the security officer and/or the user in question to login to the system and provide some input. At any given phase of the process, the system may also utilize stored information to continue the cascading of granting access privilege automatically.

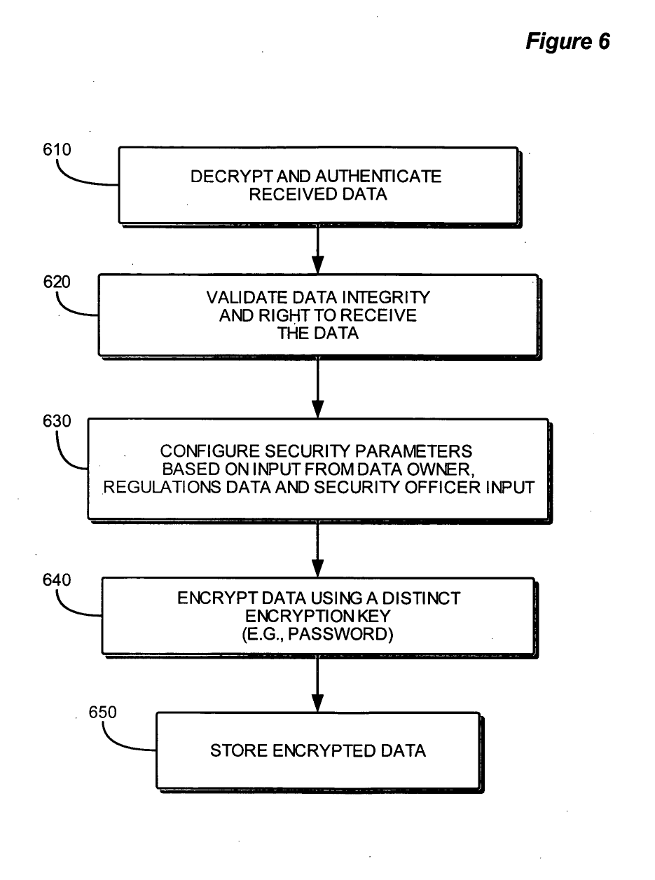

FIG. 6 is a flow chart illustrating a process for receiving and storing data that is protected under privacy laws, in accordance with an embodiment of the invention. At step 610, system 100 receives the data, which is typically encrypted, and decrypts the data using one or more decryption schemes. System 100 may also authenticate the received data. For example, system 100 may obtain a digital signature embedded with the data by accessing a third party digital signature verification system.

System 100 may check security parameters associated with related local data to determine whether the local system possesses the proper credentials to receive a specific type of information, whether the remote system possesses the proper credentials to send that data and/or whether the local system possesses the proper credentials to receive the data from a particular source. The system may also check whether the source system has the proper credentials to be distributing the data.

At step 620, system 100 validates the received data, for example, checking for integrity and access privileges, if any are already set up by the remote system. System 100 may check whether the received data has all of the components that are expected to be contained within it. As an example, if a healthcare monitoring system connects with system 100 and announces that the provided data is heart beat data, then system 100 may determine whether the data contains a number that reflects a heartbeat.

At step 630, system 100 configures the security parameters associated with the received data based on input from the data owner, data regarding privacy regulations, and security officer input. System 100 may determine that the data should be separated into portions characterized by different levels of security. Those levels may then be reflected in any access privileges granted to other parties. For example the system may determine that a user has selected to publish some of the data to a third party without any limitations, yet the system may grant access to the data only to those individuals within the third party that are involved in related operations.

In a financial environment, the data owner may choose to grant other financial institutions access to financial transactions in terms of the type of purchase made. This allows other institutions to determine the purchasing habits of that particular user. On the other hand, the data owner may select to block any access to credit information or loans for instance.

The user (e.g., the data owner) or the security officer may set up encryption schemes that are to be used for storage of the data. For example, the system may be configured by the security officer to use the password of the user to encrypt the data for storage. In other instances the security officer may use one general password for all public information and a specific individual password for each individual. The encryption keys may also involve generating a specific key for encryption. For example, instead of using the user's password, the system may combine a number of user data to generate an encryption key.

At step 640, the system encrypts the data. System 100 may use any standard encryption scheme available. It may also combine a number of different schemes and combine encryption with compression of data for minimizing storage space of data and reducing the time needed to transmit the data between machines.

At step 650 the system stores the encrypted data. As mentioned above storage may utilize any local and/or remote storage medium. Typically, the system stores the data in a relational database. The data may be stored along with a number of attributes the database utilizes to index the data for convenient searching and retrieving of information at one or more detail levels.

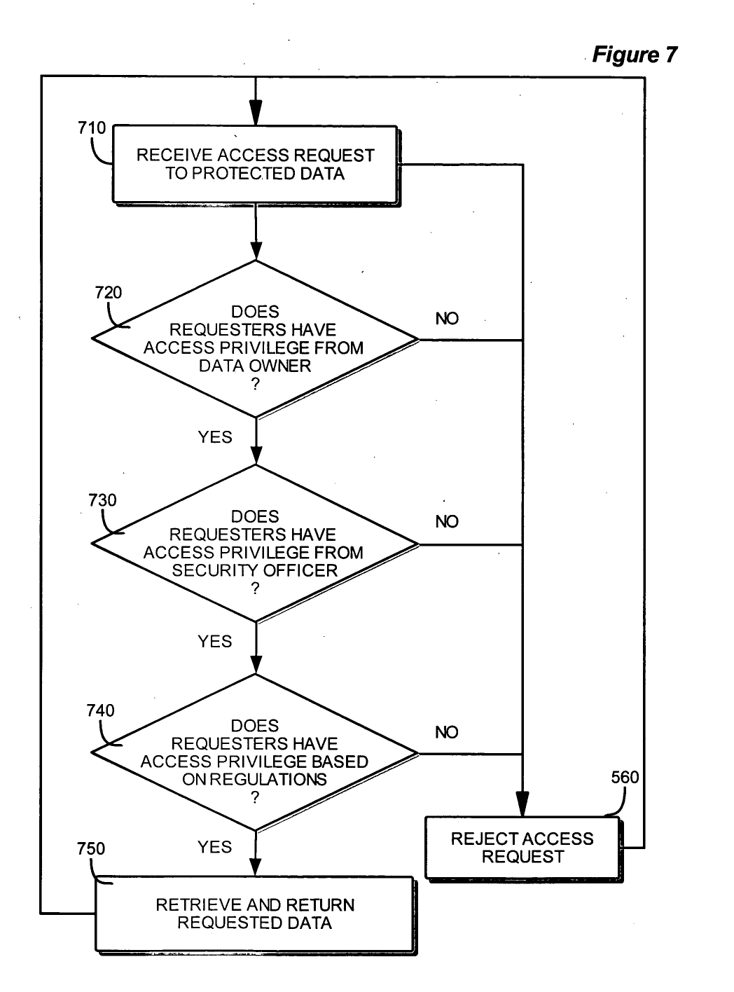

FIG. 7 is a flowchart that illustrates steps involved in accessing protected data in accordance with an embodiment of the invention. At step 710, system 100 receives a request to access protected data from a user or a third party system. Typically, a data access request comes through a secured connection, using one or more available encryption schemes. The data access request provides authentication data identifying the individual or the system requesting access to the data and allowing system 100 to authenticate that user.

For example, if a patient switches from one healthcare facility to another, the system of the second facility may be configured to automatically access the system of the first facility to request retrieval of any existing data associated with the patient. To facilitate this request, the patient attending the second hospital may provide her user input information, such as login name and password, to the data security system of the second hospital. The system of the second hospital then opens a secure connection to the system of the first hospital, and submits a data access request that identifies the request as coming from the second hospital's system and provides the user login name and password to identify the patient. The system of the first hospital authenticates that access request and utilizes the authentication information to access the information stored locally.

At step 710 of FIG. 7, system 100 checks whether the party requesting access to the data has access privileges from the data owner. If system 100 determines that the user (e.g., the data owner) has already allowed system 100 to provide access to the protected data, then system 100 checks at step 730 whether the party requesting access to the information has access privileges from the security officer.

For example, one establishment may have local rules that override other rules (e.g. regulations or user input). For example, a financial institution may have the right to disallow access to information about a user when that user goes to a different financial institution. In the latter case, the access to the information may not be granted. Alternatively, if the user is dealing with a financial institution that has a relationship with the local institution (e.g., in a partnership), then the remote system may acquire access privileges (e.g. as granted by the security officer).

At step 740, system 100 determines whether the party requesting access to the data has access privileges based on implemented regulations. If the regulation data is actually based on regulation “guidelines,” then the access privileges granted/denied based on those regulations may be overridden. However, if the regulation data reflects current law, then the granting/denying of access privileges based on the regulation data normally should not be overridden by either the user or the security officer.

If system 100 determines that the access request can be granted, then at step 750, system 100 uses the authentication information for and a request access information or the encryption keys provided locally to retrieve the data from the storage and return that in summarization to the system or the party that issued the access request. However, if any of steps 720, 730 or 740 results in a denial of access, system 100 rejects the data access request at step 560 (unless an override by the user or security officer is implemented).

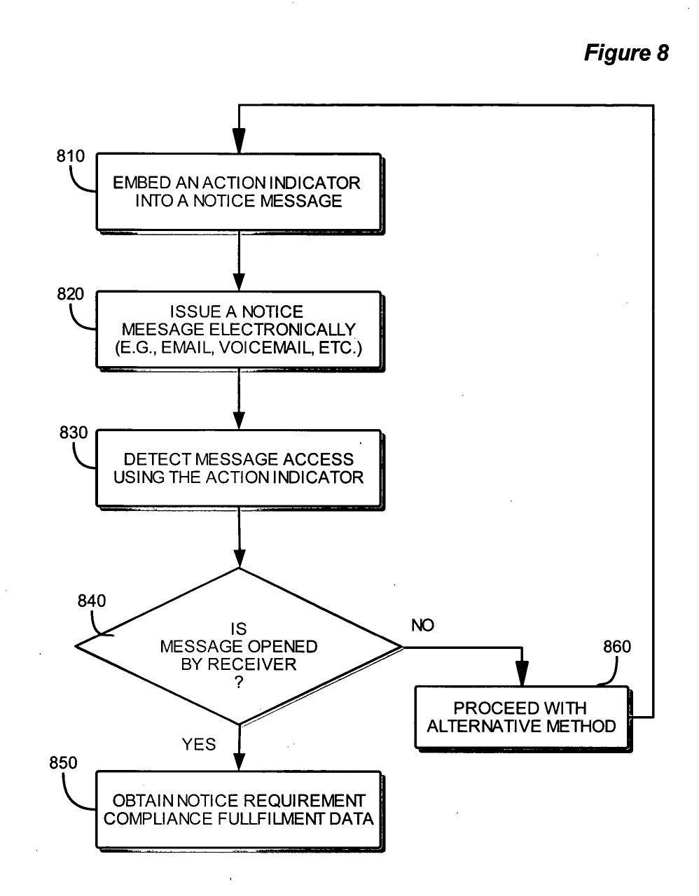

FIG. 8 is a flowchart that illustrates a process for fulfilling notice requirements, in accordance with the embodiment of the invention. Notice requirements are often part of the written rules protecting the privacy of individuals. For example, notice requirements for medical information may specify that the holder of an individual's medical information must issue a notice to that individual when activity (e.g., data access by another party, modification of data, etc.) occurs in connection with that medical information.

In accordance with one or more embodiments of the invention, at step 810 of FIG. 8, system 100 embeds an action indicator in a notice message. For example, if the system in required to take an action, and it determines that the user in question has to be notified with regard to the action, system 100 retrieves the user's contact information and produces a message informing the user of the action to be taken (to the extent specified in the relevant notice requirements).

For example, system 100 may determine that a notice can be sent to the user using electronic mail. In this situation, system 100 may confirm that the user has received the message by having an automatic return notification indicating that the message was opened. System 100 may utilize one or more techniques to provide the message to the user and to track the message to provide evidence that the user has opened the message.

An action indicator may be a “cookie,” XML, HTML or other piece of program code that is embedded in the email message and activated when the user opens the message. A message may also be contained in an attachment that requires the user to provide a password and execute the attachment in a way that displays the contents of the notice and also connects back to system 100 to provide an indication that the message in question has been opened.

The message may be included in any format that allows a message to contain an indication for notifying a server about the receipt of the message. One way of achieving that indication is by encoding the message in HTML or XML and embedding into the HTML a link for the user to click through to access a unique page identified by for example a unique URL in the message. When the web server receives a request for that unique URL it will be an indication about that user opening a particular message.

Other techniques may involve embedding graphics into the message or a request for graphics from that message. When the user opens the message, the viewing application will automatically extend a request to the web server for the specified graphics. The request may be uniquely identified (e.g. with a unique request argument in the Uniform Resource Locator, URL) that allows the web server (e.g. by logging the information) to provide an indication that the message in question was opened.

At step 820 of FIG. 8, system 100 may electronically send the notice message to the user. As previously mentioned, the message may be sent through electronic mail. An alternative method may involve voice mail. In the latter case, system 100 may send a telephone call to the user that requests the user to call back a particular number and dial an identification number, triggering playback of an audible notice message. The identification number entered informs system 100 that the message was received

At step 830, system 100 may use any of the above mentioned techniques to detect that a message addressed to user has been viewed. The action indicator may be the opening of an attachment that executes on the user's client machine, the viewing of a web page by clicking to a link embedded in a message, the detection of an embedded request for a graphic, or any other text from a message display to the user, or it may be any code required to be entered by user, for example, when receiving voicemail.

At step 840, system 100 detects the access indicator and stores the information about the receipt of the notice, fulfilling any notice requirements with respect to that user. If the system fails to receive any indication of receipt, then at step 860, system 100 may proceed with an alternative method to make sure that the notice requirement is properly fulfilled. Once the system has established that the user has been notified, then at step 850, the system records compliance data for future audit purposes.

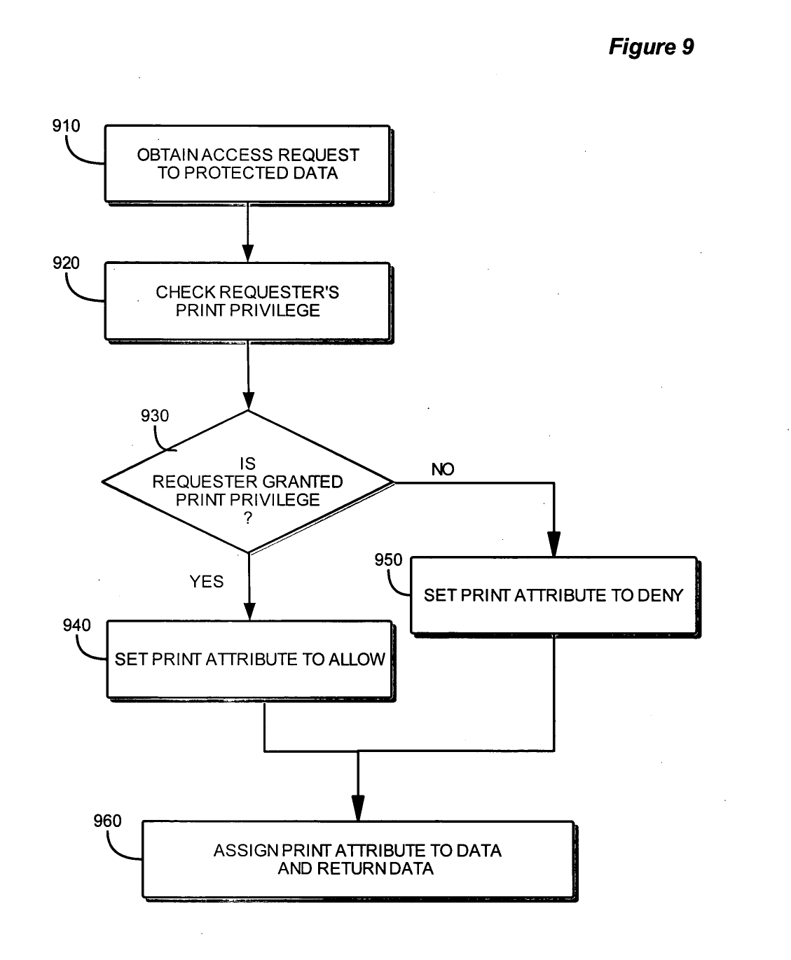

FIG. 9 is a flow chart illustrating a process for printing protected information using security attributes, in accordance with an embodiment of the invention. At step 910, system 100 obtains an access request for protected data. The request may be associated with any individual or system that is involved in accessing specific information (e.g. for viewing or updates). The system may allow an individual to access the data for viewing only, in order to protect any further distribution of the data to a third party. System 100 is configured to protect the data from being distributed electronically by providing documents that can only be viewed (i.e., not stored, transmitted or printed, etc.), such as direct images that can be displayed on a computer monitor. However, in order to protect the data from being printed, system 100 handles access privileges for printing tasks separately, and attaches specific printing attributes to the data that indicate to a receiving system whether a user has printing access levels.

At step 920, system 100 checks whether the requesting user has printing privileges (e.g., as determined by-the rules). At step 930, the system determines whether the requester can be granted printing privileges. If the system determines that the user, security officer or the regulations do not allow the requesting user to distribute the data in any form, including in print form, then system 100 sets the attributes of the data to deny any printing at step 950. If the system determines, at step 930, that a data requester may be granted print privileges, then in step 940, the print attributes to be associated with the requested data are set to allow the viewer of the data to print copies. At step 960, the print attributes are assigned to the data, and the data is transmitted to the requester.

The print attributes assigned to the data may include specific identification that allows the client system to receive and print the data. The data may be transmitted as an encrypted message that is only compatible with software for viewing the data. The data may also include other information, such as the user's identification, that is automatically printed along with the rest of the data to disclose the identity of the user distributing the data.

All of these requirements are controlled by the user's (e.g., the data owner's) security configuration input provided in connection with allowing printing privileges to be granted to an end user by the security officer, as well as the rules defined by any existing privacy regulations.

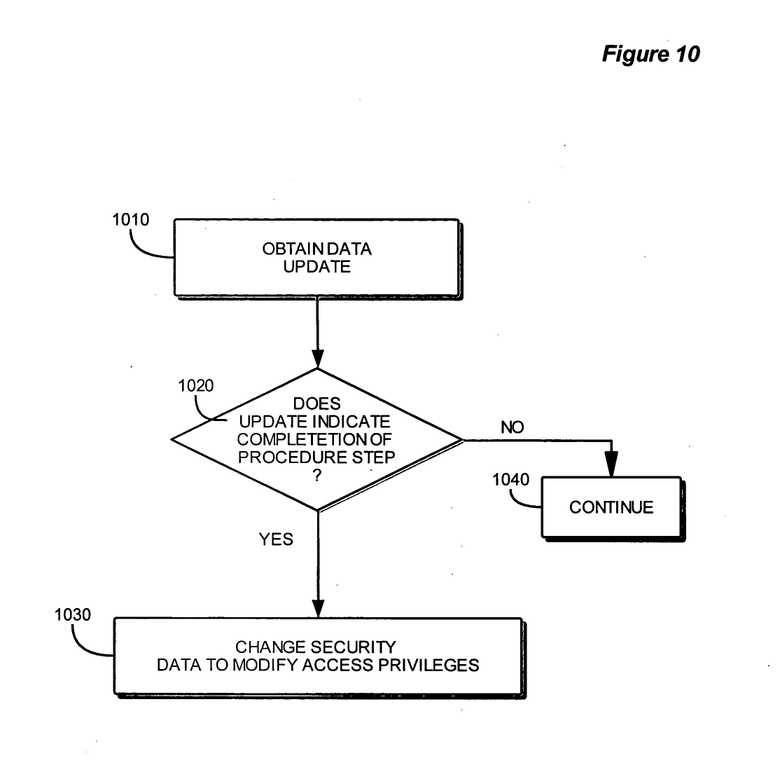

FIG. 10 is a flowchart that illustrates a process for updating security levels in response to triggering events in a multi-phase procedure, in accordance with one or more embodiments of the invention. At step 1010, system 100 obtains data update information (e.g., a user enters new data and indicates the phase is complete). The data update may be in the form of event data, such as the results of a completed step or phase within a multi-phase procedure. For example, when one department in a hospital has completed a phase of testing and inputs the test result data in the system, then the system may use that information as a completion event to trigger further processes for configuring the security parameters (e.g., to cancel the privileges of the department in the completed phase and initiate privileges for the department handling the next phase).

At step 1020, system 100 verifies the event data to validate completion of the phase. If the update event did not indicate the completion of a phase, then system 100 continues to wait for such an event at 1040. If the event data indicates completion of one or more phases in a procedure, then in step 1030, the system retrieves configuration information, such as user input, security officer input and regulation rules. That configuration information is used to determine the grant of access privileges to parties that are involved in the next phase of the procedure, and the expiration of access privileges for those parties from the completed phase that no longer have a need for access. The parties and the respective events defining the granting and canceling of access privileges may be determined by a submitted procedure plan or the person supervising the procedure, for example.

As an example of some of the process described above, for purposes of generating an invoice, system 100 may grant limited data access privileges to an accounting department, in accordance with an assigned privilege level (e.g., data access limited to the identification numbers of the procedures or health services performed for a patient). In accordance with the described scheme for event-based cascading of access privileges, the accounting department may be granted access to the procedure and service identification numbers only after each procedure or health service has been completed.

Thus a method and apparatus for securely capturing, maintaining, storing and distributing data have been provided. Particular embodiments described herein are illustrative only and should not limit the present invention thereby. The invention is defined by the claims and their full scope of equivalents.

The claimed invention is:

1. A method for providing secure storage and distribution of data comprising:
obtaining at least one set of regulation rules;
obtaining at least one set of user rules from a user;
obtaining at least one set of user data associated with said user;
managing said at least one set of user data in accordance with said at least one set of user rules and said at least one set of regulation rules.

2. The method of claim 1 wherein said obtaining said at least one set of regulation rules further comprises obtaining legal rules for protecting privacy right of individuals and organizations.

3. The method of claim 2 wherein said obtaining said legal rules further comprises obtaining rules covering health-related data of individuals.

4. The method of claim 3 wherein said rules covering health-related data further comprise HIPAA rules.

5. The method of claim 2 wherein said obtaining said legal rules further comprises obtaining rules covering financial data of individuals.

6. The method of claim 1 wherein said obtaining said at least one set of user rules further comprises obtaining a set of authorization preferences to allow other individuals access to said at least one set of user data.

7. The method of claim 1 wherein said obtaining said at least one set of user rules further comprises obtaining at least one set of authentication data for said user.

8. The method in claim 7 wherein said obtaining said at least one set of authentication data further comprises obtaining a login name and a password from said user.

9. The method of claim 7 wherein said obtaining said at least one set of authentication data further comprises encrypting said authentication data.

10. The method of claim 7 wherein said obtaining said at least one set of authentication data further comprises deriving an encryption key from said authentication data.

11. The method of claim 10 wherein deriving said encryption key further comprises utilizing said encryption key for encrypting said user data.

12. The method of claim 1 wherein said managing said at least one set of user data further comprises encrypting said at least one set of user data.

13. The method of claim 1 wherein said managing said at least one set of user data further comprises encrypting communication data for network connections.

14. The method of claim 1 wherein said managing said at least one set of user data further comprises defining a plurality of access attributes to access said at least one set of user data.

15. The method of claim 14 wherein said defining a plurality of access attributes further comprises defining said attributes based on said at least one set of regulations rules.

16. The method of claim 14 wherein said defining a plurality of access attributes further comprises defining said attributes based on said at least one set of user rules.

17. The method of claim 1 wherein said managing said at least one set of user data further comprises authenticating a data requester when data requester requests access to said at least on set of user data.

18. The method of claim 17 wherein said managing said at least one set of user data further comprises obtaining at least one access level associated with said data requester.

19. The method of claim 18 wherein said managing said at least one set of user data further comprises associating a print attribute associated with said data requester.

20. The method of claim 1 wherein said managing said at least one set of user data further comprises issuing a notice to said user.

21. The method of claim 20 wherein said issuing said notice further comprises transmitting an electronic message to said user.

22. The method of claim 21 wherein said transmitting said electronic message further comprises detecting the opening of said electronic message.

23. An apparatus for providing secure storage and distribution of data comprising:
means to obtain at least one set of regulation rules;
means to obtain at least one set of user rules from a user;
means to obtain at least one set of user data associated with said user;
means to manage said at least one set of user data in accordance with said at least one set of user rules and said at least one set of regulation rules.

24. The apparatus of claim 23 wherein said means to obtain said at least one set of regulation rules further comprises means to obtain legal rules for protecting privacy right of individuals and organizations.

25. The apparatus of claim 24 wherein said means to obtain said legal rules further comprises means to obtain rules covering health-related data of individuals.

26. The apparatus of claim 24 wherein said means to obtain said legal rules further comprises means to obtain rules covering financial data of individuals.

27. The apparatus of claim 23 wherein said means to obtain said at least one set of user rules further comprises means to obtain a set of authorization preferences to allow other individuals access to said at least one set of user data.

28. The apparatus of claim 23 wherein said means to obtain said at least one set of user rules further comprises means to obtain at least one set of authentication data for said user.

29. The method in claim 28 wherein said means to obtain said at least one set of authentication data further comprises means to obtain and a login name and password from said user.

30. The apparatus of claim 28 wherein said means to obtain said at least one set of authentication data further comprises means to encrypt said authentication data.

31. The apparatus of claim 28 wherein said means to obtain said at least one set of authentication data further comprises means to derive an encryption key from said authentication data.

32. The apparatus of claim 31 wherein data means to derive said encryption key further comprises means to utilize said encryption key for encrypting said user data.

33. The apparatus of claim 23 wherein said means to manage said at least one set of user data further comprises encrypting said at least one set of user data.

34. The apparatus of claim 23 wherein said means to manage said at least one set of user data further comprises means to encrypt communication data for network connections.

35. The apparatus of claim 23 wherein said means to manage said at least one set of user data further comprises means to define a plurality of access attributes for access said at least one set of user data.

36. The apparatus of claim 35 wherein said means to define said plurality of access attributes further comprises means to define said attributes based on said at least one set of regulations rules.

37. The apparatus of claim 35 wherein said means to define said plurality of access attributes further comprises means to define said attributes based on said at least one set of user rules.

38. The apparatus of claim 23 wherein said means to manage said at least one set of user data further comprises means to authenticate a data requester when data requester requests access to said at least on set of user data.

39. The apparatus of claim 38 wherein said means to manage said at least one set of user data further comprises means to obtain at least one access level associated with said data requester.

40. The apparatus of claim 39 wherein said means to manage said at least one set of user data further comprises means to associate a print attribute associated with said data requester.

41. The apparatus of claim 23 wherein said means to manage said at least one set of user data further comprises means to issue a notice to said user.

42. The apparatus of claim 41 wherein said means to issue said notice further comprises means to transmit an electronic message to said user.

43. The apparatus of claim 42 wherein said means to transmit said electronic message further comprises means to detect the opening of said electronic message.
